(19) United States
(12) Patent Application Publication
(10) Pub. No.: US 2014/0312776 A1
(43) Pub. Date: Oct. 23, 2014

(54) DIMMING LED LIGHTING SYSTEM

(71) Applicants: Chung Ha Park, Gyeonggi-do (KR); Seung Ryong Paik, Gyeonggi-do (KR); Dong Sun Won, Gyeonggi-do (KR)

(72) Inventors: Chung Ha Park, Gyeonggi-do (KR); Seung Ryong Paik, Gyeonggi-do (KR); Dong Sun Won, Gyeonggi-do (KR)

(73) Assignee: PLANET SYSTEM CO., LTD., Gyeonggi-do (KR)

(21) Appl. No.: 14/358,271

(22) PCT Filed: Jun. 24, 2011
(86) PCT No.: PCT/KR2011/004638

§ 371 Date: May 15, 2014

(51) Int. Cl. H05B 33/08

(52) U.S. Cl. CPC H05B 33/0845
USPC 315/129; 315/307

(57) ABSTRACT

The present invention relates to a dimming LED lighting system including a separate switch for adjusting the illumination of an LED lamp. The dimming LED lighting system according to the present invention includes a switch unit connected between a lighting switch and an on/off detection means in order to perform a snapping operation while the lighting switch is in an on state.

### TECHNICAL FIELD

The present invention relates to an LED lighting system which is capable of adjusting an illumination.

### BACKGROUND ART

In the related art, an incandescent lamp and a fluorescent lamp are mainly used as a lighting device. However, power consumption in the incandescent lamp and the fluorescent lamp is significantly high in respect to lighting efficiency and the incandescent lamp and the fluorescent lamp consume approximately 2.1 trillion kWh of annual power consumption through lighting equipment worldwide. This corresponds to 12 to 15% of a total power and the incandescent lamp and the fluorescent lamp annually emit 17 hundred million CO₂. Further, the fluorescent lamp is manufactured using mercury and needs to be frequently replaced due to a short lifespan. Therefore, if the fluorescent lamp is not appropriately collected and discarded, serious environmental contamination may be caused. Due to such problems, according to recent actual circumstances, environmental regulations are globally enhanced, for example, some countries have banned the sale of the incandescent lamp and the fluorescent lamp.

Therefore, recently, a light which has an excellent energy saving effect and uses an eco-friendly light emitting diode (LED) is in the spotlight. The LED light has a long life-span, a high brightness, and a low power consumption property which results in saving energy. If 30% of light in Korea is replaced with the LED light by 2015, approximately 16 billion kW of power saving effect and approximately 6.8 million tons of CO₂ reduction effect every year have been calculated, which is well known. Further, an LED lamp is considered as means for replacing a down-light which is implemented by an incandescent lamp or a halogen lamp among traditional lights.

Currently, the LED light is configured by a lighting switch 11, a lighting wiring line 12, and a socket 13 which are used in the existing incandescent lamp or fluorescent lamp and an LED lamp 14 which is replaced for the lamp, as illustrated in FIG. 1. Such an LED light uses a lighting switch 11 which is used in the related art only to control only turning on/off the LED lamp 14 but cannot control the illumination.

Therefore, an illumination controllable LED light further includes an illumination control switch 21, an illumination control wiring line 22, a control device 23, and an LED lamp 24, in addition to the lighting switch 11 and the lighting wiring line 12 of the related art, as illustrated in FIG. 2.

That is, the lighting switch 11 is used to control turning on/off the LED light 24 and the illumination control switch 21 is used to adjust an illumination of the LED lamp 24. By doing this, the control device 23 drives the LED lamp 24 in response to the on/off control of the lighting switch 11 and illumination control of the illumination control switch 21.

In the case of the illumination controllable LED light of the related art, additional wiring work is required in addition to the lighting wiring line 12 of the related art and work to mount an additional switch is required such that the installation becomes complex and more cost is required.

### DETAILED DESCRIPTION OF THE INVENTION

### Technical Problem

The present invention has been made in an effort to provide an LED lighting system which is capable of adjusting illumination which controls to turn on/off an LED lamp and illumination without providing an additional illumination control switch and an illumination control wiring line and easily controls illumination of the LED lamp using a switch for dimming control by a user.

### Technical Solution

An exemplary embodiment of the present invention provides an LED lighting system capable of adjusting illumination, including: a detecting unit which detects on and off statuses of a lighting switch; a dimming determining unit which receives information on the on/off status of the lighting switch from the detecting unit to determine a snapping operation of the lighting switch and output a dimming signal; a dimming adjusting unit which adjusts an illumination of the LED lamp when the dimming signal is input from the dimming determining unit; a power holding circuit unit which supplies a driving power to the LED lamp in accordance with the snapping operation at the time of the snapping operation of the lighting switch; and a switch unit which is connected between the lighting switch and the detecting unit to perform the snapping operation when the lighting switch is turned on.

### Advantageous Effects

According to the present invention, a control device and an LED lamp are replaced from a general lighting system of the related art to control turning on/off the LED lamp and illumination so that a lifespan of the light is increased, additional electricity saving effect by controlling the illumination is obtained, and sensitive lighting may be provided by controlling the illumination.

### BRIEF DESCRIPTION OF DRAWINGS

FIG. 1 is a view illustrating an LED lighting system of the related art.

FIG. 2 is a view illustrating an illumination controllable LED lighting system of the related art.

FIG. 3 is a view illustrating a lighting system including a control device of an LED lamp according to the present invention.

FIGS. 4A and 4B are diagrams illustrating a switch for dimming control according to a first exemplary embodiment of the present invention, in which FIG. 4A is an exterior view and FIG. 4B is an internal circuit diagram thereof.

FIGS. 5A and 5B are diagrams illustrating a switch for dimming control according to a second exemplary embodiment of the present invention in which FIG. 5A is an exterior view and FIG. 5B is an internal circuit diagram thereof.

FIGS. 6A and 6B are diagrams illustrating a switch for dimming control according to a third exemplary embodiment of the present invention in which FIG. 6A is an exterior view and FIG. 6B is an internal circuit diagram thereof.

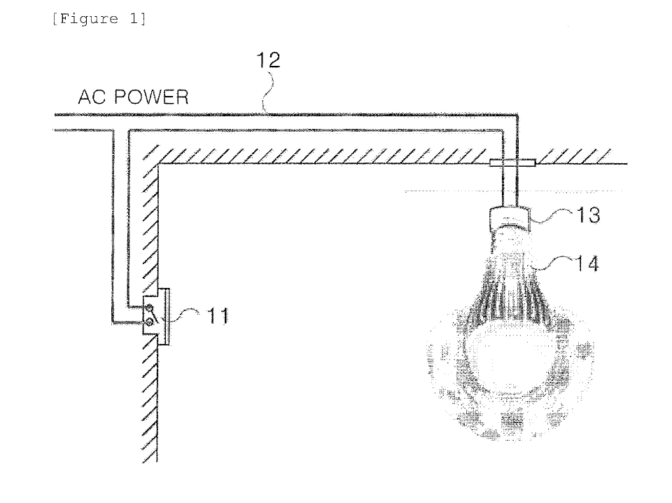

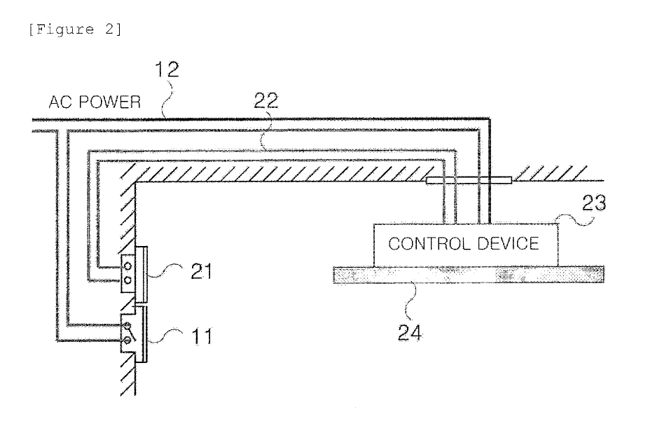

### BEST MODE

Those skilled in the art may make various modifications to the present invention and the present invention may have various exemplary embodiments thereof, and thus specific exemplary embodiments will be illustrated in the drawings and described in detail in detailed description.

However, this does not limit the present invention within specific exemplary embodiments, and it should be understood that the present invention covers all the modifications, equivalents and replacements within the spirit and technical scope of the present invention.

Terminologies including an ordinary number, such as first and second, are used for describing various constituent elements, but the constituent elements are not limited by the terms.

The above terminologies are used only to discriminate one component from another component. For example, without departing from the scope of the present invention, a second component may be referred to as a first component, and similarly, a first component may be referred to as a second component.

It should be understood that, when it is described that an element is “coupled” or “connected” to another element, the element may be directly coupled or directly connected to the other element or coupled or connected to the other element through a third element. On the contrary, it should be understood that when an element is referred to as being “directly connected to” or “directly coupled to” another element, another element does not intervene therebetween.

Terminologies used in the present application are used only to describe specific exemplary embodiments, and are not intended to limit the present invention. A singular form may include a plural form if there is no clearly opposite meaning in the context.

In the present invention, it should be understood that terminology “include” or “have” indicates that a feature, a number, a step, an operation, a component, a part or the combination those of described in the specification is present, but do not exclude a possibility of presence or addition of one or more other features, numbers, steps, operations, components, parts or combinations, in advance.

Further, it is understood that the drawings attached in this application are exaggerated or reduced for the convenience of description.

Hereinafter, an illumination adjustable LED lighting system according to an exemplary embodiment of the present invention will be described in detail with reference to the accompanying drawings.

FIG. 3 is a view of an LED lighting system according to an exemplary embodiment of the present invention.

As illustrated in the drawing, an LED lighting system according to the present invention includes a lighting switch 11, a lighting wiring line 12, an LED lamp control device 30, and an LED lamp 24.

The LED lamp control device 30 includes an AC/DC converter unit 31, an on/off detecting means which detects an on/off status of the lighting switch, a dimming determining means which receives information on the on/off status of the lighting switch from the on/off detecting means to determine the snapping operation of the lighting switch to output a dimming signal, a dimming adjusting means which adjusts an illumination of the LED lamp when a dimming signal is input from the dimming determining means, a power holding circuit unit 42 which supplies a driving power to the LED lamp when the lighting switch performs a snapping operation, and a power off means which turns off the LED lamp when the off status information of the lighting switch is input from the on/off detecting means and an off status of the lighting switch exceeds a threshold time.

The lighting switch 11 is connected to the AC power source in series through the lighting wiring line 12 to supply the AC power to the LED lamp 24 or shut off the AC power. When a user turns off the lighting switch 11 for a while in the on status and then turns on the lighting switch 11 again, that is, the lighting switch 11 is turned off for a while in the on status and then turned on again (which is referred to as a snapping operation), the LED lamp control device 30 recognizes the snapping operation as a dimming control signal.

The on/off detecting means includes a zero cross detector unit 32, an undetected counter unit 33, and a clock 34. The dimming determining means includes a storing unit 41, a first comparator 39, and a dimming determining unit 37. The power off means includes a storing unit 41, a second comparator 40, and a power off determining unit 38. The dimming adjusting means includes a dimming step counter unit 36 and a dimming adjusting unit 35.

In the LED lighting system according to the present invention, when the user turns on the lighting switch 11, the LED lamp 24 is turned on at a maximum brightness. In a status when the LED lamp 24 is turned on, when the lighting switch 11 is turned off for a while (a dimming threshold time) and then turned on, an illumination of the LED lamp is adjusted to be lowered by one step at a time. When the operation stops at a brightness which is desired by the user, the status is maintained. When a predetermined time elapses after the user turns off the lighting switch, all operations are reset to turn off the LED lamp.

That is, in the LED lighting system of FIG. 3, when the user wants to dim the illumination by one step at a time, the lighting switch 11 needs to be turned off for a while and then turned on. In this case, the off time needs to be longer than the dimming threshold time but shorter than a power off determining time. If the off time is shorter than the dimming threshold time, the dimming control is not performed but if the off time is longer than the power off determining time, the LED lamp is completely turned off.

In order to control the dimming of the LED lamp using the lighting switch 11, the user needs to perform snapping for a time which is longer than the dimming threshold time and shorter than the power off determining time so that a dimming function is hard to be used.

The present invention has been made to solve the above-mentioned problems, and further includes a switch for dimming control which provides a dimming control signal which is longer than the dimming threshold time and shorter than the power off determining time to the LED lamp control device 30 by only one manipulation of the user.

That is, in the LED lighting system of FIG. 3, when the user manually snaps the lighting switch 11, the LED lamp control device 30 recognizes the snapping operation to adjust the illumination of the LED lamp 24. In contrast, according to the present invention, the switch for dimming control is manipulated while the lighting switch 11 is turned on of the related art, so that the same effect as the snapping of the lighting switch 11 is obtained. Therefore, the user may easily control the dimming of the LED lamp.

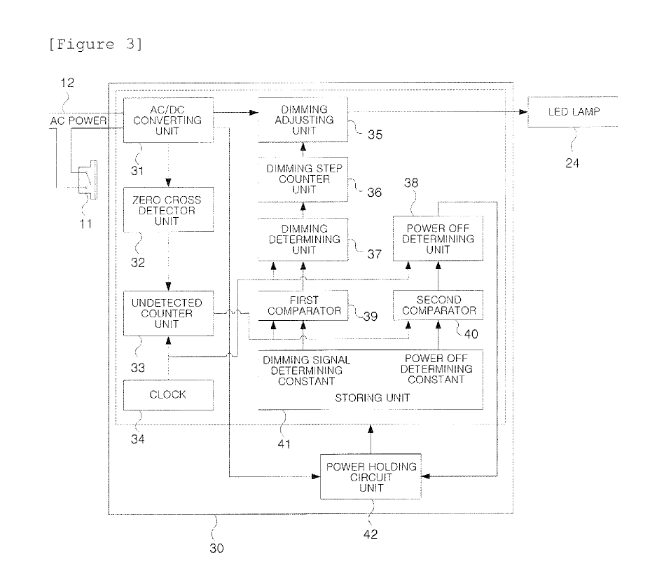

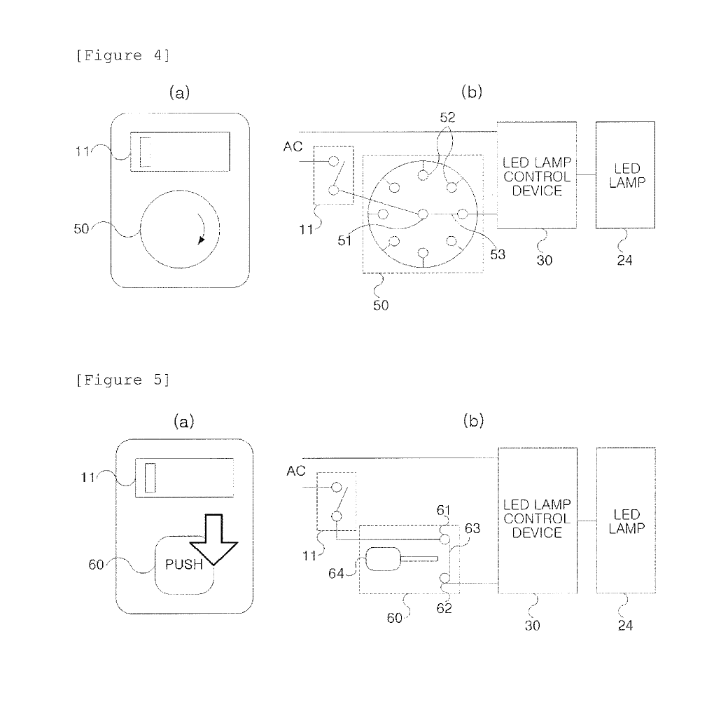

FIGS. 4A and 4B are diagrams illustrating a switch for dimming control according to a first exemplary embodiment of the present invention, in which FIG. 4A is an exterior view and FIG. 4B is an internal circuit diagram the.

A switch for dimming control according to a first exemplary embodiment of the present invention is implemented by a rotary switch 50. The rotary switch 50 includes a first contact 51 which is connected to the lighting switch 11, a plurality of second contacts 52 which is arranged around a circle having the first contact 51 as a center at a unit angle interval and electrically connected to each other to be connected to the on/off detecting means of the LED lamp control device 30, and a rotor 53 having an end which is connected to the first contact 51 and the other end which rotates around the circle to be in contact with the plurality of second contacts 52.

When the user manipulates (rotates) the rotary switch 50 once while the rotor 53 is in contact with any one of the second contacts 52, the rotor 53 rotates by a unit angle at a time until the rotor 53 is in contact with an adjacent second contact 52. That is, power is applied to the LED lamp control device 30 while the rotor 53 is in contact with an arbitrary second contact 52 and the power is shut off from the LED lamp control device 30 while the rotor 53 moves between arbitrary two adjacent second contacts 52. According to the present invention, the rotor 53 moves between arbitrary two adjacent second contacts 52 while the rotary switch 50 rotates, so that even though the user manipulates the rotary switch 50 once, a dimming control signal which is longer than the dimming threshold time and shorter than the power off determining time is supplied to the LED lamp control device 30 and the LED lamp control device 30 may control the illumination of the LED lamp in accordance with the input dimming control signal.

FIGS. 5A and 5B are diagrams illustrating a switch for dimming control according to a second exemplary embodiment of the present invention in which FIG. 5A is an exterior view and FIG. 5B is an internal circuit diagram thereof. A switch for dimming control according to a second exemplary embodiment of the present invention is implemented by a push button switch 60. The push button switch 60 includes a first contact 61 which is connected to a lighting switch 11, a second contact 62 which is connected to an on/off detecting means of the LED lamp control device 30, a coupler 63 which is contact with the first contact 61 and the second contact 62, a push button 64 which disposes the coupler 63 to be spaced apart from the first contact 61 or the second contact 62 when the pressing operation is performed by a user, and a restoring means (not illustrated) which allows the coupler 63 to be in contact with the first contact 61 and the second contact 62 when a predetermined time elapses after manipulating the push button 64.

When the user does not press the push button 64, the first contact 61, the coupler 63, and the second contact 62 are electrically connected so that when the lighting switch 11 is turned on, the power is supplied to the LED lamp control device 30. In the meantime, when the user presses the push button 64, the coupler 63 moves by the push button 64 so that the first contact 61, the coupler 63, and the second contact 62 are disconnected and then the contact 61, the coupler 63, and the second contact 62 are electrically connected again by the restoring means after the predetermined time has elapsed.

As described above, when the user manipulates the push button 64 once, the power of the push button switch 60 is autonomously off and then on, so that a dimming control signal which is longer than a dimming threshold time and shorter than a power off determining time is supplied to the LED lamp control device 30 and the LED lamp control device 30 may control the illumination of the LED lamp in accordance with an input dimming control signal. When the user releases the manipulation of the push button 64 and then manipulates the push button 64 again, a dimming control signal is further supplied to further control the illumination of the LED lamp in accordance with the dimming signal.

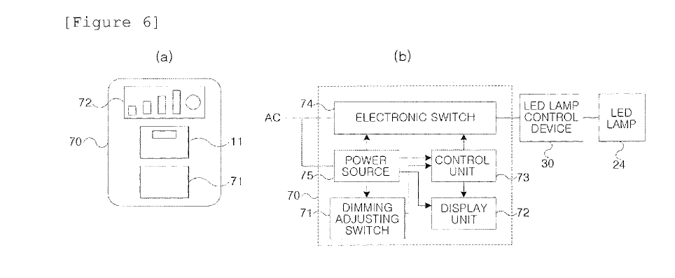

FIGS. 6A and 6B are diagrams illustrating a switch for dimming control according to a third exemplary embodiment of the present invention in which FIG. 6A is an exterior view and FIG. 6B is an internal circuit diagram thereof.

A switch for dimming control according to a third exemplary embodiment of the present invention is implemented by an electronic switching device 70. The electronic switching device 70 includes a lighting switch 11, a dimming adjusting switch 71, and a display unit 72.

Further, the electronic switching device 70 further includes a control unit 73 which detects a manipulating status of the dimming adjusting switch 71 to output a dimming control signal, an electronic switch 74 which switches between an input power source and an on/off detecting means of the LED lamp control device 30 in accordance with the dimming control signal of the control unit 73 to output the dimming signal to the LED lamp control device 30, and a power source 75 which generates a driving power from the input power source when the lighting switch 11 is turned on to supply the driving power to internal components of the electronic switching device 70. The control unit 73 displays a current on/off status of the LED lamp and a dimming level on the display unit 72. The electronic switching device may be implemented by a three wire switch or two wire clockcon switch.

When the user manipulates the dimming adjusting switch 71, the control unit 73 recognizes the manipulation and outputs the dimming control signal to the electronic switch 74 so that the electronic switch 74 temporally shuts off the input power which is supplied to the LED lamp control device 30 and then connects to the power supply. By doing this, the LED lamp control device 30 recognizes this as a dimming control signal to control the illumination of the LED lamp.

The control unit 73 performs a predefined macro function (a function of performing a plurality of predefined continuous operations). For example, the dimming adjusting switch 71 further includes a macro selecting function (for example, a function of selecting a sleeping mode) and when the user manipulates the function of selecting a sleeping mode, the control unit outputs a dimming control signal at a predetermined interval for a predetermined time and then turns off the power. By doing this, the LED lamp control device 30 controls the illumination of the LED lamp to be darker and then turn off the LED lamp after the predetermined time.

The electronic switch 74 may be configured by a relay or a TRIAC (triode AC) switch. The dimming adjusting switch 71 is implemented by a remote controller receiving unit (not illustrated) to adjust a dimming level of the LED lamp using a remote controller or further includes the remote controller receiving unit (not illustrated) in addition to the dimming adjusting switch 71 to adjust the dimming level of the LED lamp using the remote controller.

1. An LED lighting system, comprising:
a detecting unit which detects on and off statuses of a lighting switch;
a dimming determining unit which receives information on the on/off status of the lighting switch from the detecting unit to determine a snapping operation of the lighting switch and output a dimming signal;
a dimming adjusting unit which adjusts an illumination of the LED lamp when the dimming signal is input from the dimming determining unit;
a power holding circuit unit which supplies a driving power to the LED lamp in accordance with the snapping operation at the time of the snapping operation of the lighting switch; and
a switch unit which is connected between the lighting switch and the detecting unit to perform the snapping operation when the lighting switch is turned on.

2. The LED lighting system of claim 1, wherein the switch unit is a rotary switch.

3. The LED lighting system of claim 2, wherein the rotary switch includes:
a first contact which is connected to the lighting switch;
a plurality of second contacts which is arranged around a circle having the first contact as a center at a predetermined interval and electrically connected to each other to be connected to the detecting unit; and
a rotor having an end which is connected to the first contact and the other end which is in contact with one of the plurality of second contacts.

4. The LED lighting system of claim 3, wherein when there is an input from a user, the rotary switch rotates until the rotor is in contact with an adjacent second contact among the plurality of second contacts.

5. The LED lighting system of claim 2, wherein the rotary switch supplies a dimming control signal which is longer than a dimming threshold time and shorter than a power off determining time to the detecting unit.

6. The LED lighting system of claim 1, wherein the switch unit is a push button switch.

7. The LED lighting system of claim 6, wherein the push button switch includes:
a first contact which is connected to the lighting switch;
a second contact which is connected to the detecting unit;
a coupler which is in contact with the first contact and the second contact;
a push button which disposes the coupler to be spaced apart from the first contact or the second contact; and
a restoring unit which allows the coupler to be in contact with the first contact and the second contact when a predetermined time elapses after the user performs a pressing operation.

8. The LED lighting system of claim 7, wherein the push button switch supplies a dimming control signal which is longer than a dimming threshold time and shorter than a power off determining time to the detecting unit.

9. The LED lighting system of claim 1, wherein the switch unit includes:
a dimming adjusting switch to which a dimming adjusting level is input;
a control unit which detects a manipulating status of the dimming adjusting switch to output a dimming control signal; and
an electronic switch which outputs a dimming signal in accordance with the dimming control signal of the control unit.

10. The LED lighting system of claim 9, wherein the switch unit further includes:
a display unit which receives and displays an on/off status of the LED lamp and dimming level information from the control unit.

11. The LED lighting system of claim 9, wherein when a macro function is performed through the dimming adjusting switch, the control unit performs a plurality of continuous operations which is predefined by the macro.

12. The LED lighting system of claim 9, wherein the electronic switch is a relay or a TRIAC switch.

13. The LED lighting system of claim 9, wherein the switch unit supplies a dimming control signal which is longer than a dimming threshold time and shorter than a power off determining time to the detecting unit.

14. The LED lighting system of claim 1, wherein the power holding circuit unit supplies a driving power to the LED lamp while the dimming control signal whose input power is shut off for a time which is longer than the dimming threshold time and shorter than the power off determining time is input.
